(19) United States
(12) Patent Application Publication
(10) Pub. No.: US 2005/0159516 A1
(43) Pub. Date: Jul. 21, 2005

(54) Halogen-free flame-retardant resin composition and prepreg and laminate using the same

(76) Inventors: Yoon-kyung Kwon, Seoul (KR); Eun-hae Koo, Daejeon (KR); Mok-yong Jung, Daejeon (KR)

Correspondence Address: MCKENNA LONG & ALDRIDGE LLP, 1900 K STREET, NW, WASHINGTON, DC, 20006, US

(21) Appl. No.: 11/033,746

(22) Filed: Jan. 13, 2005

(30) Foreign Application Priority Data
Jan. 16, 2004 (KR) 10-2004-0003360

(51) Int. Cl. C08K 5/34; C08K 3/40

(52) U.S. Cl. 524/96; 524/494

(57) ABSTRACT

The present invention relates to a halogen-free flame-retardant resin composition and a prepreg and a copper clad laminate using the same. The present invention provides a halogen-free flame-retardant resin composition comprising a polyphosphate compound as phosphorus-based flame retardant and a prepreg and a copper clad laminate using the same.

The resin composition of the present invention has superior flame retardancy without using a halogen-based flame retardant. Also, because it has superior heat resistance, a high glass transition temperature (T_{g}), good copper peeling strength and superior lead heat resistance after moisture absorption, it can be utilized in a copper clad laminate for printed circuit boards, etc.

### TECHNICAL FIELD

The present invention relates to a halogen-free flame-retardant resin composition used for a printed circuit board (PCB) and a prepreg and a laminate using the same.

### BACKGROUND ART

With the recent concerns about global environmental problems, regulations about generation of toxic materials during disposal of electric and electronic products are becoming stricter. In general, the conventional resin composition for prepregs and laminates employs brominated difunctional epoxy resin and multi-functional epoxy resin as main components and amine based curing agent and curing accelerator. The epoxy composition contains 15-20 wt % of bromine to comply with the 94V-0 flame retardation standard of UL (Underwriters Laboratory).

Although the bromine-containing halogen compound has superior flame retardancy, a toxic gas is generated during its combustion. Because the halogen-containing material may produce dioxin, which is a carcinogen, its use is strongly regulated. Also, use of antimony, which is another carcinogen, is strongly regulated. Besides, use of lead, whish is used in manufacturing a printed wiring, is strongly regulated, because it is toxic and may cause environmental pollution. Therefore, a better heat resistance is required as a higher melting point is needed for soldering. For these reasons, compounds having dihydrobenzoxadine rings, which contain a lot of nitrogen atoms, have been introduced to improve flame retardancy of the resin and replace bromine-containing epoxy resin compositions. Also, introduction of condensed phosphate ester, reactive phosphate ester, phosphorus-containing epoxy resin, phosphorus- or nitrogen-containing phenol resin, flame-retardant inorganic filler, etc. is under consideration.

Aforementioned introduction of compounds having dihydrobenzoxadine rings are disclosed in Japan Patent Publication Nos. 2003-213077, 2003-206390, 2002-249639 and 2001-302879 and U.S. Pat. No. 5,946,222. Japan Patent Publication No. 2003-206390 and U.S. Pat. No. 5,946,222 disclose the reaction of a compound having an intramolecular dihydrobenzoxadine ring and a novolak phenol resin. In this case, a high glass transition temperature and a good heat resistance are attained, but it is difficult to satisfy the UL 94V-0 flame retardancy standard with the resin composition alone. Japan Patent Publication Nos. 2003-213077 and 2001-302879 disclose the introduction of a halogen-free condensed phosphate ester or a reactive phosphate ester and an inorganic flame retardant to a compound obtained by reacting a compound having an intramolecular dihydrobenzoxadine ring, an epoxy resin and a phenol resin. Japan Patent Publication No. 2002-249639 discloses the introduction of a melamine-modified phenol resin, a halogen-free condensed phosphate ester and an inorganic flame retardant to a compound having an intramolecular dihydrobenzoxadine ring as a halogen-free flame retardant. Because the halogen-free condensed phosphate ester and the reactive phosphate ester are soluble in most organic solvents, it is easy to prepare a varnish. Also, because they are highly compatible with an epoxy resin, the resultant prepreg has a good appearance. But, they have poor heat resistance and high hygroscopy and so the resultant resin composition has poor heat resistance and lead heat resistance after moisture absorption. Also, because they melt at a temperature below 100° C., the flowing property of the resultant resin composition becomes increase and so its thickness control is difficult during pressing. In particular, although a single phase is obtained because the reactive phosphate ester participates in curing, the glass transition temperature decreases significantly. In Japan Patent Publication No. 2001-302870, phosphorus- or nitrogen-containing epoxy resin or phenol resin is used to improve flame retardancy. In this case, the flame retardancy is improved and a single phase is obtained. But, the glass transition temperature decreases and the heat resistance becomes poor.

Phosphorus-based flame retardants, which contain phosphorus in their molecular backbone, produce phosphates and such radicals as HPO, PO, etc., during combustion. The radicals trap such reactive radicals as H or OH and the decomposed phosphates or polyphosphates form highly viscous melt glass material or compact char, which blocks heat and oxygen.

Typical examples of the conventional phosphorus-based flame retardant are halogen-free phosphate ester, halogen-free condensed phosphate ester, halogenated phosphate ester, halogenated condensed phosphate ester, polyphosphate, phosphorus red, etc. Examples of the halogen-free phosphate ester are triphenyl phosphate (TPP), tricredyl phosphate (TCP), credyldiphenyl phosphate (CDP), 2-ethylhexyl phosphate (ODP), isodecyldiphenyl phosphate (IDDP), lauryldiphenyl phosphate (LPD), etc. Example of the halogen-free condensed phosphate ester is condensed type resorcinol bisphenyl phosphate (RDP). A reactive resorcinol bisphenyl Phosphate (RDP), which has OH groups at the terminal, HCA-HQ, etc. are also condensed phosphate esters.

The halogen-free phosphate ester or the halogen-free condensed phosphate ester is widely used as flame retardant in engineering plastics due to its superior flame retardancy and relatively low price. Also, because it is soluble inmost organic solvent, it can be easily prepared into a varnish or prepreg. However, because it melts at a low temperature of 100° C. or below, it tends to flow during pressing, which makes thickness control of a copper clad laminate difficult. Also, it is highly volatile because of low molecular weight, which causes blocking of pipes during treatment and lowers adhesivity as it migrates onto the surface. Besides, the compound itself has poor heat resistance and moisture resistance. In particular, a reactive condensed phosphate ester such as reactive RDP, HCA-HQ, etc., which takes part in reaction, gives a single phase but significantly reduces the glass transition temperature. Although the halogenated phosphate ester or the halogenated condensed phosphate ester has superior flame retardancy thanks to the synergic effect of phosphorus and halogen, it is inadequate because it may cause environmental pollution. Phosphorus red has superior flame retardancy. But, it ignites easily and may cause environmental pollution. Thus, its use is regulated likewise a halogen-based flame retardant.

### DISCLOSURE OF INVENTION

In order to solve these problems, it is an object of the present invention to provide a halogen-free flame-retardant resin composition for a copper clad laminate not producing a toxic carcinogen such as dioxin during combustion, improving flame retardancy, having superior heat resistance and a high glass transition temperature and having superior lead heat resistance after moisture absorption.

It is another object of the present invention to provide a flame-retardant prepreg and a flame-retardant copper clad laminate employing the halogen-free flame-retardant resin composition.

To attain the objects, the present invention provides a halogen-free flame-retardant resin composition for a copper clad laminate comprising (A) a compound having an intramolecular dihydrobenzoxadine ring, (B) an epoxy resin, (C) a novolak or resol phenol resin, (D) a polyphosphate compound and (E) an inorganic filler.

Preferably, the polyphosphate compound has a thermal decomposition temperature measured by thermal gravimetric analysis (TGA) of at least 300° C. and a hygroscopy of at most 0.5%. The polyphosphate compound may contain a nitrogen atom.

The present invention also provides a prepreg comprising 40-70 wt % of the resin composition and 30-60 wt % of glass fiber.

The present invention further provides a copper clad laminate obtained by laminating the prepreg into at least one layer, positioning a copper layer outside the prepreg laminate and applying heat and pressure.

Hereunder is given a more detailed description of the present invention.

The halogen-free flame-retardant resin composition of the present invention is characterized by using a polyphosphate compound, which is a phosphorus-based flame retardant, instead of the conventional halogen-based flame retardant.

Because the present invention does not use a halogen-based flame retardant, no toxic carcinogen, such as dioxin, is generated during combustion. Also, as a compound having an intramolecular dihydrobenzoxadine ring is introduced, the resultant resin has improved flame retardancy and heat resistance and a higher glass transition temperature.

The halogen-free flame-retardant resin composition of the present invention comprises (A) a compound having an intra molecular dihydrobenzoxadine ring, (B) an epoxy resin, (C) a novolak or resol phenol resin, (D) a polyphosphate compound and (E) an inorganic filler.

(A) The compound having an intramolecular dihydrobenzoxadine ring may be any compound that has a dihydrobenzoxadine ring and is cured by opening of the dihydrobenzoxadine ring. It is synthesized from a compound having a phenolic hydroxy group, a primary amine and formaldehyde.

The compound having an intramolecular dihydrobenzoxadine ring includes the compound represented by the following Chemical Formula 1: 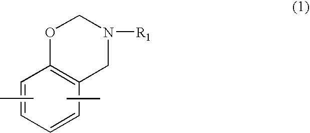
wherein R₁ is alkyl, cyclohexyl, phenyl, or phenyl substituted by alkyl or alkoxy.

Examples of the compound having a phenolic hydroxy group are polyfunctional phenols, biphenol compounds, bisphenol compounds, trisphenol compounds, tetraphenol compounds, phenol resins, etc. Examples of the polyfunctional phenols are catechol, hydroquinone, resorcinol, etc. Examples of the bisphenol compounds are bisphenol A, bisphenol F and its positional isomer, bisphenol S, etc. Examples of the phenol resins are a phenol novolak resin, a resol phenol resin, a phenol-modified xylene resin, an alkyl phenol resin, a melamine phenol resin, a phenol-modified polybutadiene resin, etc. Examples of the primary amines are methylamine, cyclohexylamine, aniline, substituted aniline, etc. In case an aliphatic primary amine is used, the curing rate increases but the heat resistance worsens. In case an aromatic amine, e.g., aniline, is used, the heat resistance is improved but the curing rate decreases.

(A) The compound having an intramolecular dihydrobenzoxadine ring may be prepared by adding 0.5-1.5 mole, preferably 0.6-1.0 mole, of a primary amine per 1 mole of a compound having a phenolic hydroxy group, heating the mixture to 50-60° C., adding 1.5-2.5 moles, preferably 1.9-2.1 moles, of formaldehyde per 1 mole of the primary amine, heating to 60-120° C., preferably to 90-110° C., performing reaction for 60-120 minutes and drying under reduced pressure at a temperature of at least 100° C.

(A) The compound having an intramolecular dihydrobenzoxadine ring is used in 20-95 parts by weight, preferably 50-90 parts by weight, per 100 parts by weight of (A) the compound having an intramolecular dihydrobenzoxadine ring plus (B) the epoxy resin [(A)+(B)=100]. If the content of the (A) the compound having an intramolecular dihydrobenzoxadine ring falls too small, the flame retardancy of the resin worsens, making difficult to achieve the UL 94V-0 flame retardancy standard, the glass transition temperature decreases and the heat resistance and hygroscopy worsen. Otherwise, if the content of (A) the compound having an intramolecular dihydrobenzoxadine ring is too large, the curing time during pressing increases, the product tends to crack during drilling because the curing backbone becomes hard, a high temperature is required for prepreg manufacturing and the appearance of the prepreg worsens.

The followings are non-limiting examples of (B) the epoxy resin.
<Bisphenol A Type Epoxy Resin> 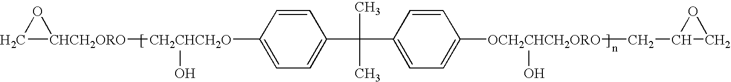
<Phenol Novolak Epoxy Resin> 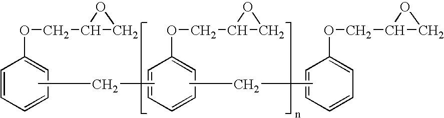
<Tetraphenyl Ethane Epoxy Resin> 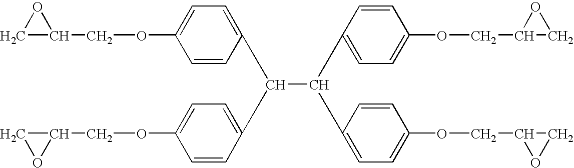
<Dicyclopentadiene Epoxy Resin> 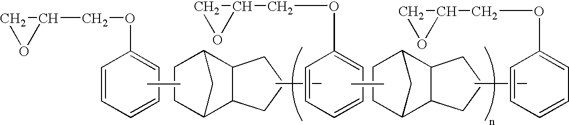
<Bisphenol A Novolak Epoxy Resin>

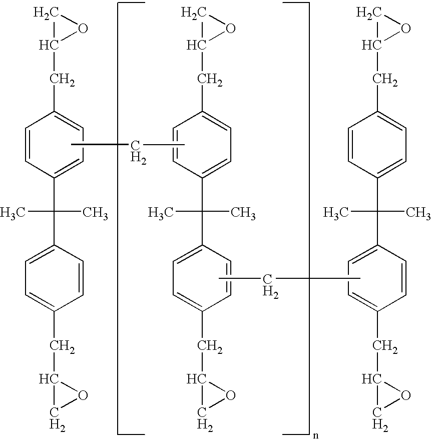

(B) The epoxy resin is used in 5-80 parts by weight, preferably in 10-50 parts by weight, per 100 parts by weight of (A) the compound having an intra molecular dihydrobenzoxadine ring plus (B) the epoxy resin [(A)+(B)=100]. If the content of (B) the epoxy resin is too small, the curing time increases, the product tends to crack during drilling because the curing backbone becomes hard, a high temperature is required for prepreg manufacturing and the appearance of the prepreg worsens. Otherwise, if the content of (B) the epoxy resin is too large, the flame retardancy of the resin worsens, making difficult to achieve the UL 94V-0 flame retardancy standard, the glass transition temperature decreases and the heat resistance and hygroscopy worsen significantly.

(C) The phenol resin may be a novolak or resol phenol resin. The novolak phenol resin may be a phenol novolak resin, a bisphenol A novolak resin, a cresol novolak resin, a phenol-modified xylene resin, an alkyl phenol resin, a melamine-modified resin , etc. The resol phenol resin may be a phenol type, a cresol type, an alkyl type, a bisphenol A type or a copolymer thereof. (C) The phenol resin is comprised in 5-80 parts by weight, preferably in 10-50parts by weight, per 100 parts by weight of (A) the compound having an intramolecular dihydrobenzoxadine ring plus (B) the epoxy resin [(A)+(B)=100]. If the content of the phenol resin is less than 5 parts by weight, the curing time increases and the heat resistance and the mechanical property worsen because of low crosslinking density. Otherwise, if the content of the phenol resin exceeds 80 parts by weight, the heat resistance, the glass transition temperature and the mechanical property worsen because of low crosslinking density, and the hygroscopy increases.

The resin composition of the present invention may further comprise a curing accelerator. The curing accelerator is preferably an imidazole based curing accelerator. For example, an imidazole and an imidazole derivative such as 1-methylimidazole, 2-methylimidazole, 2-ethyl-4-methylimidazole, 2-phenylimidazole, 2-cyclohexyl-4-methylimidazole, 4-butyl-5-ethylimidazole, 2-methyl-5-ethyl imidazole, 2-octyl-4-hexylimidazole, 2,5-chloro-4-ethylimidazoleand2-butoxy-4-allylimidazolemay be used. In particular, 2-methylimidazole or 2-phenyl imidazole, which has superior reaction stability and is inexpensive, is preferable. The imidazole based curing accelerator is used in 0.01-0.1 part by weight, more preferably in0.03-0.06 part by weight, per 100 parts by weight of the resin composition except for the filler. If the content of the imidazole based curing accelerator is less than 0.01 part by weight, the curing time increases and the glass transition temperature becomes low. Otherwise, if it exceeds 0.1 part by weight, the storage stability of the varnish worsens.

(D) The polyphosphate compound, which is a phosphorus-based flame retardant, is prepared by substituting a phosphorus compound with a metal substituent or substituting urea, melamine, cyanurate or melamine-cyanurate with phosphorus and a metal substituent. It is unreactive because it has no reactive group like OH at the terminal. Differently from the conventional phosphate ester or condensed phosphate ester, it is not soluble in an organic solvent and does not participate in reaction. Thus, it is used as filler like an inorganic filler. Although the polyphosphate compound is an organic compound, it also has an inorganic characteristic. In case it contains a nitrogen atom, the nitrogen gas formed during its combustion blocks oxygen, which further improves flame retardancy. Unlike the conventional halogen-free phosphate ester or halogen-free condensed phosphate ester, it has superior heat resistance and low hygroscopy. Also, it is in volatile because it has a large molecular weight, causing no pipe blocking during treatment. In addition, because it does not melt, thickness control during pressing is not difficult, differently from the halogen-free phosphate ester or the halogen-free condensed phosphate ester. Besides, because it does not participate in reaction, unlike the reactive phosphate ester, it does not lower the glass transition temperature.

In case only an inorganic flame retardant like aluminum hydroxide or magnesium hydroxide is used without (D) the polyphosphate compound, the flame retardancy is significantly reduced. Thus, in order to achieve the UL 94V-0 flame retardancy standard, an excessive amount of inorganic flame retardant should be used. In this case, adhesivity and heat resistance worsen significantly. Also, because aluminum hydroxide is decomposed at about 230° C., the heat resistance worsens further. While magnesium hydroxide is decomposed at a temperature about 100° C. higher, a further more amount should be used because of poor flame retardancy.

Because (D) the polyphosphate compound has a flame retardancy superior to that of the conventional inorganic flame retardant, the UL 94V-0 flame retardancy standard can be attained without adding an excessive amount. Thus, the problems of adhesivity or filler dispersion are solved. (D) The polyphosphate compound has a thermal decomposition temperature measured by thermal gravimetric analysis (TGA) of at least 300° C. and a hygroscopy of at most 0.5%, preferably at most 0.2%. Thus, it has good heat resistance and low hygroscopy.

(D) The polyphosphate compound preferably has a particle size of 0.1-15 μm, more preferably 1-5 μm. If the particle size is smaller than 0.1 μm, the specific gravity becomes too small, thereby making treatment difficult and the production yield becomes low, thereby increasing production cost. Otherwise, if it exceeds 15 μm, the filler dispersion becomes difficult and the adhesivity worsens.

(D) The polyphosphate compound contains 5-60 wt %, preferably 9-30 wt %, of phosphorus in the molecular backbone. If the phosphorus content is below 5 wt %, an excessive amount of filler has to be used to attain a sufficient flame retardancy, which impairs appearance of the prepreg and reduces adhesivity. Otherwise, if it exceeds 60 wt %, the heat resistance and the moisture resistance worsen.

(D) The polyphosphate compound is used, so that the phosphorus content becomes preferably 2-10 wt %, more preferably 3-5 wt %, per 100 wt % of the resin except for the filler.

A suitable dispersing agent and an adequate dispersion method are selected to uniformly disperse (D) the polyphosphate compound and prevent its sedimentation.

(E) The inorganic filler may be aluminum hydroxide, magnesium hydroxide, antimony oxide, tin hydroxide, tin oxide, molybdenumoxide, a zirconium compound, a borate, a calcium salt, ammonium octamolybdate, talc, silica, alumina, etc. Among these, aluminum hydroxide, magnesium hydroxide, antimony oxide, tin hydroxide, tin oxide, molybdenum oxide, a zirconium compound, borate, a calcium salt and ammonium octamolybdate may further improve the flame retardancy when used along with a phosphorus-based flame retardant. Also, because talc, silica and alumina have good heat resistance and low hygroscopy, they further improve heat resistance of the resin composition and lead heat resistance after moisture absorption. (E) The inorganic filler is preferably comprised in 3-50parts by weight, more preferably in 5-30 parts by weight, per 100 parts by weight of the resin excluding the filler. If the content of the inorganic filler is below 3 parts by weight, the expected effect may not be attained. Otherwise, if it exceeds 50 parts by weight, filler dispersion becomes difficult and heat resistance and adhesivity worsen.

A suitable dispersing agent and an adequate dispersion method are applied to uniformly disperse (E) the inorganic filler and prevent its sedimentation.

The present invention also provides a prepreg comprising the halogen-free flame-retardant resin composition inside a glass fiber. Preferably, the prepreg comprises 30-60 wt % of glass fiber and 40-70 wt % of the halogen-free flame-retardant resin composition.

The present invention further provides a copper clad laminate prepared by laminating the prepreg into at least one layer, positioning a copper layer outside the prepreg laminate and applying heat and pressure. Also, a copper clad laminate may be prepared by pressing conducting material sheets (e.g., copper sheets) on both sides of the prepreg, which has been laminated into 1-8 layers, with heat and pressure.

As described above, the resin composition of the present invention employs a compound having an intramolecular dihydrobenzoxadine ring and uses a phosphorus-based flame retardant having superior heat resistance and low hygroscopy instead of the conventional halogen-based flame retardant or halogen-free condensed phosphate ester. Thus, it is unharmful to human because it does not produce carcinogens such as dioxin during combustion and has a high glass transition temperature, good flame retardancy, heat resistance and lead heat resistance after moisture absorption.

Hereinafter, the present invention is described in more detail through examples. However, the following examples are only for the understanding of the present invention and the present invention is not limited to or by them.

### BEST MODE FOR CARRYING OUT THE INVENTION

### EXAMPLE 1

(Preparation of Compound Having Intramolecular Dihydrobenzoxadine Ring)

1.7 kg of phenol novolak resin (KPH-F-2001, Kolon Chemical of Korea) was mixed with 1.5 kg of aniline. After mixing at 60° C. for 1 hour, 1.6 kg of formaldehyde was added to a 5 L flask equipped with a reflux unit. Maintaining the temperature at 100° C., the mixture solution of novolak resin and aniline was slowly added for 30 minutes. After 1 hour, the reaction mixture was dried under reduced pressure at 120° C. to obtain a compound having an intramolecular dihydrobenzoxadine ring. Hereunder, the resultant resin is expressed as “BE.”

(Dispersion of Polyphosphate Compound and Inorganic Filler)

2.4 parts by weight of a dispersing agent(BYK W903, BYK Chemie) was completely dissolved with 100 parts by weight of methyl ethyl ketone in a 500 mL beaker. Then, 80 parts by weight of a polyphosphate compound (phosphorus content=23%, Exolit OP 930, Clariant of Germany) and 120 parts by weight of silica (SFP-30M, Denka of Japan) were added. The mixture was stirred using a high-speed mixer at 11,000 rpm for 20 minutes, so that the filler was dispersed uniformly. The polyphosphate compound (Exolit OP 930) was a compound prepared by substituting diethylphosphinic acid with aluminum. It had a TGA thermal decomposition temperature of at least 400° C., a hygroscopy of at most 0.2% and a particle size of 3-7 μm.

(Preparation of Halogen-Free Resin Composition)

A halogen-free resin composition was prepared with the composition presented in Table 1 below.

240 parts by weight of the compound having an intramolecular dihydrobenzoxadine ring (BE) was put in a 1,000 mL beaker. Then, 100parts by weight of methyl ethyl ketone was added to completely dissolve the compound. Then, 160 parts by weight of phenol novolak epoxy resin (LER N-690, Bakelite Korea), 120 parts by weight of phenol novolak resin(KPH F-2000, Kolon Chemical of Korea) and 0.2 part by weight of 2-methylimidazole were added and completely dissolved. Next, the slurry in which the polyphosphate compound and the inorganic filler had been dispersed was added to the mixture solution. Methyl ethyl ketone was added until the solid content reached 65%. The mixture was stirred until the slurry was completely mixed to obtain a halogen-free resin composition.

### EXAMPLE 2

A halogen-free resin composition was prepared with the composition presented in Table 1.

A resin composition was prepared in the same manner of Example 1, except that 120 parts by weight of bisphenol A novolak epoxy resin(LER N865, Bakelite Korea) was used instead of 160 parts by weight of phenol novolak epoxy resin and 160 parts by weight of bisphenol A novolak resin (VH4170, Kangnam Chemical of Korea) was used instead of 120 parts by weight of phenol novolak resin.

### EXAMPLE 3

A halogen-free resin composition was prepared with the composition presented in Table 1.

A resin composition was prepared in the same manner of Example 1, except that 320 parts by weight of the compound having an intramolecular dihydrobenzoxadine ring (BE) was used instead of 240 parts by weight, 80 parts by weight of phenol novolak epoxy resin was used instead of 160 parts by weight, 120 parts by weight of bisphenol A type resol resin (CKA908, Kolon Chemical of Korea) was used instead of 120parts by weight of phenol novolak resin, 120 parts by weight of a polyphosphate compound (phosphorus content=23%, Exolit OP 930, Clariant of Germany) was used instead of 80 parts by weight and 80 parts by weight of silica (Min U sil-5, US of USA) instead of 120 parts by weight of silica (SFP-30M, Denka of Japan).

### EXAMPLE 4

A halogen-free resin composition was prepared with the composition presented in Table 2 below.

A resin composition was prepared in the same manner of Example 1, except that 160 parts by weight of a nitrogen-containing polyphosphate compound (phosphorus content=14%, Arafil 72, Vantico of Taiwan) was used instead of 80 parts by weight of the polyphosphate compound (phosphorus content=23%, Exolit OP 930, Clariant of Germany) and 40 parts by weight of aluminum hydroxide (TS-601, Martinswerk of Germany) was used instead of 120 parts by weight of silica (SFP-30M, Denkaof Japan). The nitrogen-containing polyphosphate compound (Arafil 72) was a compound prepared by substituting a nitrogen based compound with phosphorus and aluminum. It had a TGA thermalde composition temperature of at least 300° C., a hygroscopy of at most 0.2% and a particles size of at most about 2 μm.

### EXAMPLE 5

A halogen-free resin composition was prepared with the composition presented in Table 2.

A resin composition was prepared in the same manner of Example 1, except that 320 parts by weight of the compound having an intramolecular dihydrobenzoxadine ring (BE) was used instead of 240 parts by weight, 80 parts by weight of phenol novolak epoxy resin(LER N-690, Bakelite Korea) was used instead of 160 parts by weight, 160 parts by weight of a nitrogen-containing polyphosphate compound (phosphorus content=14%, Arafil72, Vantico of Taiwan) was used instead of 80 parts by weight of the polyphosphate compound (phosphorus content=23%, Exolit OP 930, Clariant of Germany) and 80 parts by weight of silica (Min U sil-5, US of USA) was used instead of 120 parts by weight of silica (SFP-30M, Denka of Japan).

### EXAMPLE 6

A halogen-free resin composition was prepared with the composition presented in Table 2.

A resin composition was prepared in the same manner of Example 1, except that 160 parts by weight of a nitrogen-containing polyphosphate compound (phosphorus content=11%, Nonfla601, Dubon of Korea)was used instead of 80 parts by weight of the polyphosphate compound (phosphorus content=23%, Exolit OP 930, Clariant of Germany) and 80 parts by weight of silica (Min U sil-5, US of USA) was used instead of silica (SFP-30M, Denka of Japan). The nitrogen-containing polyphosphate compound (Nonfla601) was a compound prepared by substituting melamine-cyanurate with phosphorus and aluminum. It had a TGA thermal decomposition temperature of at least 350° C., a hygroscopy of at most 0.3% and a particle size of at most about 2 μm.

### COMPARATIVE EXAMPLE 1

A halogen-free resin composition was prepared with the composition presented in Table 3 below.

A resin composition was prepared in the same manner of Example 1, except that 400 parts by weight of bisphenol A novolak epoxy resin (LER N865, Bakelite Korea) was used instead of 240 parts by weight of the compound having an intramolecular dihydrobenzoxadine ring (BE) and 160 parts by weight of phenol novolak epoxy resin, 216.6 parts by weight of bisphenol A novolak phenol resin (VH4170, Kangnam Chemical of Korea) was used instead of 120 parts by weight of phenol novolak resin, 0.6 part by weight of 2-methylimidazole was used instead of 0.2 part by weight, 100 parts by weight of the polyphosphate compound (phosphorus content=23%, Exolit OP 930, Clariant of Germany) was used instead of 80 parts by weight and 150 parts by weight of silica (SFP-30M, Denka of Japan) was used instead of 120 parts by weight.

### COMPARATIVE EXAMPLE 2

A halogen-free resin composition was prepared with the composition presented in Table 3.

A resin composition was prepared in the same manner of Example 1, except that 180 parts by weight of condensed phosphate ester (phosphorus content=9%, Nonfla500, Dubon of Korea) was used instead of 80 parts by weight of the polyphosphate compound (phosphorus content=23%, Exolit OP 930, Clariant of Germany) and 120 parts by weight of aluminum hydroxide (TS-601, Martinswerk of Germany) was used instead of silica (SFP-30M, Denka of Japan).

### COMPARATIVE EXAMPLE 3

A halogen-free resin composition was prepared with the composition presented in Table 3. A resin composition was prepared in the same manner of Example 1, except that 120 parts by weight of melamine-modified novolak resin (YLH828, Epoxy Resin of Japan) was used instead of 120parts by weight of phenol novolak resin (KPH F-2000, Kolon Chemical of Korea), 180 parts by weight of a reactive phosphorus compound (phosphorus content=9%, HCA-HQ, Sanko of Japan) was used instead of 80 parts by weight of the polyphosphate compound (phosphorus content=23%, Exolit OP 930, Clariant of Germany) and 120 parts by weight of aluminum hydroxide (TS-601, Martinswerk of Germany) was used instead of silica (SFP-30M, Denka of Japan).

### TESTING EXAMPLE

(Preparation of Copper Clad Laminate)

Each resin composition prepared in Examples and Comparative Examples was impregnated into glass fiber (7628, Nittobo) and dried with hot air to obtain a glass fiber prepreg having a resin content of 43 wt %.

8 sheets of the glass fiber prepreg were laminated. Then, two sheets of copper film having a thickness of 35 μm were positioned on up and down of the laminate and were laminated. Heat and pressure were applied using a press with a temperature of 195° C. and a pressure of 40 kg/cm² for 90 minutes to obtain a copper clad laminate having a thickness of 1.6 mm.

(Testing of Copper Clad Laminate)

Physical properties of the copper clad laminate were tested as follows. The result is presented in Tables 1-3.

1) Varnish gelation time was measured by filling 0.5 mL of varnish into the groove (diameter=2 cm, height=0.5 cm) of a hot plate, the temperature of which was maintained at 170° C., and stirring the varnish with a stick. The time required for the resin to completely harden was measured.

2) The copper layer of the copper clad laminate was removed by etching and glass transition temperature was measured using a DSC (differential scanning calorimeter).

3) Copper peeling strength was measured with a texture analyzer while peeling 1 cm width of copper film from the surface of the copper clad laminate.

4) Lead heat resistance was measured by the time that a 5 cm×5 cm×1.6 mm sample endures in a lead bath of 288° C.

5) Lead heat resistance after moisture absorption was evaluated by treating three 5 cm×5 cm×1.6 mm samples under the PCT (pressure cooker test) condition of 120° C., 2 atm and 100% humidity for 2 hours and immersing them in a lead bath of 288° C. for 10 seconds. Lead heat resistance was evaluated depending on the degree of expansion.

⊚: No expansion at all.

∘: Expanded in part.

Δ: Mostly expanded.

×: Expanded on the whole surface.

6) Flame retardancy was measured according to the UL94 flame retardancy standard test method using a rod-type sample prepared by using the copper film-removed laminate. According to the method, flame retardancy was evaluated as V-0, V-1 and V-2.

TABLE 1

| Category | | Example 1 | Example 2 | Example 3 |
|---|---|---|---|---|
| Resin | Compound having | 240 | 240 | 320 |
| composition | dihydrobenzoxadine ring (BE) | | | |
| | Phenol novolak epoxy resin | 160 | — | 80 |
| | Bisphenol A novolak epoxy resin | — | 120 | — |
| | Phenol novolak resin | 120 | — | — |
| | Bisphenol A novolak resin | — | 160 | — |
| | Bisphenol A resol resin | — | — | 120 |
| | 2-Methylimidazole | 0.2 | 0.2 | 0.2 |
| | Γ-Glycydoxypropyltrimethoxysilane | 2.4 | 2.4 | 2.4 |
| Filler | Exolit OP 930 (phosphorus | 80 | 80 | 120 |
| composition | content = 23%) | | | |
| | Arafil72 (phosphorus content = 14%) | — | — | — |
| | Nonfla601 (phosphorus content = 11%) | — | — | — |
| | SFP-30M | 120 | 120 | — |
| | Min U sil-5 | — | — | 80 |
| | TS-601 | — | — | — |
| Phosphorus content based on the resin | | 3.5 | 3.5 | 5.3 |
| composition (wt %) | | | | |
| Physical | Varnish gelation time (sec) | 446 | 443 | 475 |
| properties | Glass transition temperature | 162 | 165 | 169 |
| | (° C.) | | | |
| | Copper peeling strength (kN/m) | 1.4 | 1.4 | 1.3 |
| | Lead heat resistance (sec) | 380 | 370 | 350 |
| | Lead heat resistance after | ⊚⊚⊚ | ⊚⊚⊚ | ⊚⊚⊚ |
| | moisture absorption | | | |
| | Flame retardancy (UL94) | V-0 | V-0 | V-0 |

TABLE 2

| Category | | Example 4 | Example 5 | Example 6 |
|---|---|---|---|---|
| Resin | Compound having | 240 | 320 | 240 |
| composition | dihydrobenzoxadine ring (BE) | | | |
| | Phenol novolak epoxy resin | 160 | 80 | 160 |
| | Bisphenol A novolak epoxy resin | — | — | — |
| | Phenol novolak resin | 120 | 120 | 120 |
| | Bisphenol A novolak resin | — | — | — |
| | Bisphenol A resol resin | — | — | — |
| | 2-Methylimidazole | 0.2 | 0.2 | 0.2 |
| | γ-Glycydoxypropyltrimethoxysilane | 2.4 | 2.4 | 2.4 |
| Filler | Exolit OP 930 (phosphorus | — | — | — |
| composition | content = 23%) | | | |
| | Arafil72 (phosphorus content = 14%) | 160 | 160 | — |
| | Nonfla601 (phosphorus content = 11%) | — | — | 160 |
| | SFP-30M | — | — | — |
| | Min U sil-5 | — | 80 | 80 |
| | TS-601 | 40 | — | — |
| Phosphorus content based on the resin | | 4.3 | 4.3 | 4.3 |
| composition (wt %) | | | | |
| Physical | Varnish gelation time (sec) | 264 | 245 | 391 |
| properties | Glass transition temperature | 176 | 181 | 172 |
| | (° C.) | | | |
| | Copper peeling strength (kN/m) | 1.8 | 1.7 | 1.7 |
| | Lead heat resistance (sec) | 320 | 440 | 380 |
| | Lead heat resistance after | ◯◯◯ | ◯◯◯ | ◯◯◯ |
| | moisture absorption | | | |
| | Flame retardancy (UL94) | V-1 | V-0 | V-0 |

As seen in Tables 1 and 2, when Exolit OP 930, a polyphosphate compound, was used as phosphorus-based flame retardant (Examples 1-3) , good flame retardancy, a high glass transition temperature, superior heat resistance and lead heat resistance after moisture absorption were attained. Also, when Arafil72 (Examples 4 and 5) and Nonfla601 (Example 6) were used, a good flame retardancy, high copper peeling strength and a high glass transition temperature were attained.

TABLE 3

| | | Comp. | Comp. | Comp. |
|---|---|---|---|---|
| Category | | Example 1 | Example 2 | Example 3 |
| Resin | Compound having | — | 240 | 240 |
| composition | dihydrobenzoxadine ring (BE) | | | |
| | Phenol novolak epoxy resin | — | 160 | 160 |
| | Bisphenol A novolak epoxy resin | 400 | — | — |
| | Phenol novolak resin | — | 120 | — |
| | Bisphenol A novolak resin | 216.6 | — | — |
| | Melamin-modified novolak resin | — | — | 120 |
| | 2-Methylimidazole | 0.6 | 0.2 | 0.2 |
| | γ-Glycydoxypropyltrimethoxysilane | 2.4 | 2.4 | 2.4 |
| Filler | Exolit OP 930 (phosphorus | 100 | — | — |
| composition | content = 23%) | | | |
| | Nonfla500 (phosphorus content = 9%) | — | 180 | — |
| | HCA-HQ (phosphorus content = 9%) | — | — | 180 |
| | SFP-30M | 150 | — | — |
| | Min U sil-5 | — | — | — |
| | TS-601 | — | 120 | 120 |
| Phosphorus content based on the resin | | 3.7 | 3.1 | 3.1 |
| composition (wt %) | | | | |
| Physical | Varnish gelation time (sec) | 380 | 300 | 240 |
| properties | Glass transition temperature | 152 | 146 | 132 |
| | (° C.) | | | |
| | Copper peeling strength (kN/m) | 1.1 | 1.4 | 1.6 |
| | Lead heat resistance (sec) | 342 | 20 | 49 |
| | Lead heat resistance after | ⊚⊚⊚ | xxx | xΔΔ |
| | moisture absorption | | | |
| | Flame retardancy (UL94) | V-1 | V-0 | V-0 |

As seen in Table 3, when bisphenol A novolak epoxy resin was used instead of the compound having an intramolecular dihydrobenzoxadine ring (Comparative Example 1), heat resistance and lead heat resistance after moisture absorption were superior, but flame retardancy did not satisfy the UL 94V-0 standard and copper peeling strength decreased significantly. And, when Nonfla500, a condensed phosphate ester, (Comparative Example 2) and HCA-HQ, a reactive phosphate ester, (Comparative Example 3) were used, flame retardancy was good, but heat resistance and lead heat resistance after moisture absorption decreased. Particularly, when HCA-HQ was used (Comparative Example 3), the glass transition temperature decreased a lot because OH groups of the HCA-HQ participated in reaction.

Industrial Applicability

The halogen-free resin composition of the present invention does not produce toxic carcinogens such as dioxin during combustion and has improved flame retardancy and heat resistance thanks to the compound having an intramolecular dihydrobenzoxadine ring. Also, because a polyphosphate based compound, all the terminal OH groups of which has been substituted, is used as phosphorus-based flame retardant, it has good flame retardancy, superior heat resistance and lead heat resistance after moisture absorption while maintaining the glass transition temperature, if adequately used along with an inorganic filler.

While the present invention has been described in detail with reference to the preferred embodiments, those skilled in the art will appreciate that various modifications and substitutions can be made thereto without departing from the spirit and scope of the present invention as set forth in the appended claims.

1. A halogen-free flame-retardant resin composition for a copper clad laminate comprising (A) a compound having an intramolecular dihydrobenzoxadine ring, (B) an epoxy resin, (C) a novolak or resol phenol resin, (D) a polyphosphate compound and (E) an inorganic filler.

2. The resin composition of claim 1, wherein (A) the compound having an intramolecular dihydrobenzoxadine ring is prepared from ring opening of dihydrobenzoxadine by reacting 0.5-1.5 mol of a primary amine per 1 mol of a compound having a phenolic hydroxy group and adding 1.5-2.5 mol of formaldehyde per 1 mol of the primary amine.

3. The resin composition of claim 1, wherein (A) the compound having an intramolecular dihydrobenzoxadine ring is a compound represented by the following Chemical Formula 1: 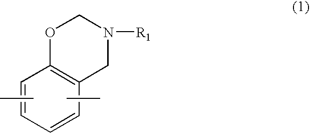
wherein R₁ is alkyl, cyclohexyl, phenyl, or phenyl substituted by alkyl or alkoxy.

4. The resin composition of claim 1, wherein (A) the compound having an intramolecular dihydrobenzoxadine ring is comprised in 20-95 parts by weight per 100 parts by weight of (A) the compound having an intramolecular dihydrobenzoxadine ring plus (B) the epoxy resin.

5. The resin composition of claim 1, wherein (B) the epoxy resin is comprised in 5-80 parts by weight per 100 parts by weight of (A) the compound having an intramolecular dihydrobenzoxadine ring plus (B) the epoxy resin.

6. The resin composition of claim 1, wherein (C) the novolak or resol phenol resin is comprised in 5-80 parts by weight per 100 parts by weight of (A) the compound having an intramolecular dihydrobenzoxadine ring plus (B) the epoxy resin.

7. The resin composition of claim 1, wherein (D) the polyphosphate compound has a thermal decomposition temperature measured by thermal gravimetric analysis (TGA) of at least 300° C. and a hygroscopy of at most 0.5%.

8. The resin composition of claim 1, wherein (D) the polyphosphate compound is prepared by substituting a phosphorus compound with a metal substituent or substituting urea, melamine, cyanurate or melamine-cyanurate with phosphorus and a metal substituent.

9. The resin composition of claim 1, wherein (D) the polyphosphate compound contains 5-60% of phosphorus and has a particle size of 0.1-15 μm.

10. The resin composition of claim 1, wherein (D) the polyphosphate compound is comprised, so that the phosphorus content becomes 2-10% per 100 parts by weight of the resin excluding fillers.

11. The resin composition of claim 1, wherein (E) the inorganic filler is comprised in 3-50 parts by weight per 100 parts by weight of the resin excluding fillers.

12. A prepreg comprising 40-70 wt % of the resin composition of claim 1 and 30-60 wt % of glass fiber.

13. A copper clad laminate prepared by laminating the prepreg of claim 12 into at least one layer, positioning a copper layer outside of the prepreg laminate and applying heat and pressure.
